(19) United States
(12) Patent Application Publication
(10) Pub. No.: US 2016/0084341 A1
(43) Pub. Date: Mar. 24, 2016

(54) Vibration Isolation System for Components of HVAC Equipment and the Like

(71) Applicant: Seicon Limited, Hilliard, OH (US)

(72) Inventor: James A. Baron, Hilliard, OH (US)

(21) Appl. No.: 14/864,373

(22) Filed: Sep. 24, 2015

Related U.S. Application Data
(60) Provisional application No. 62/054,840, filed on Sep. 24, 2014.

(51) Int. Cl. F16F 15/08

(52) U.S. Cl. CPC F16F 15/08

(57) ABSTRACT

A vibration isolation assembly for mounting a vibration source to a support structure includes a first support member configured to be secured to the support structure, a second support member configured to be secured to the vibration source, and at least three vibration isolators located between the first and second supports and secured to the first and second support members to isolate the support structure from the vibration source. The vibration isolators each include an elastically flexible member capable of bending in response to load applied to the elastically flexible member so that the elastically flexible member oscillates in response to vibration of the vibration source to at least partially isolate the vibration source from the support structure. Longitudinal axes of the elastically flexible members are located within a horizontal plane and the elastically flexible members are oriented so that at least one of the elastically flexible members isolates vibration in every horizontal lateral direction.

### CROSS-REFERENCE TO RELATED APPLICATIONS

This application claims the priority benefit of U.S. Provisional Patent Application No. 62/054,840 filed on Sep. 24, 2014, the disclosure of which is expressly incorporated herein in its entirety by reference.

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to vibration isolation systems and, more particularly, to vibration isolation systems for vibration-producing components of HVAC equipment and the Like.

### BACKGROUND OF THE INVENTION

Heating ventilating and air conditioning (HVAC) equipment, particularly air conditioners, can be relatively noisy. Even residential air conditioning units that are typically located outside the home can create more noise than desired. HVAC equipment typically has at least one vibration source, such as a compressor for example, that contributes much of the noise because the vibration transfers to surrounding housings, mounting structures, etc. to produce noise. When the HVAC equipment is mounted to a building structure, the building structure can even noticeably move and shake due to the vibration which transfers from the mounting structure of the HVAC equipment to the building structure. As a result, it is desirable to mount the HVAC equipment and/or its vibration-producing components in a manner to isolate the vibration produced by the HVAC equipment.

There are many existing means for isolating objects from shocks and vibration. For example, FIG. 1 illustrates a typical residential air conditioning or condenser unit 10 which is mounted outside a residence. The illustrated residential air conditioning unit 10 includes a bottom baseplate or pan 12 that is supported on a concrete pad or the like outside the residence. A vented cabinet or housing 14 is secured to the bottom pan 12 to form an enclosed hollow interior space 16 above the bottom pan 12 for components of the residential air-conditioning unit 10. Mounted within the cabinet 14 is at least one vibration-producing component such as the illustrated compressor 18. The illustrated compressor 18 is oriented with a vertically-extending axis of rotational and is attached to the top of the bottom pan 12 with threaded fasteners 20 with elastomeric mounts 22 located between the compressor 18 and the bottom pan 12 so that the elastomeric mounts 22 isolate the bottom pan 12 from the shock and vibration produced by the compressor 18. While this isolation method is somewhat effective, it is less than desirable and there is a continuing desire to further reduce transfer of the vibration to reduce noise caused thereby.

Accordingly, there is a need in the art for improved vibration isolation systems for vibration-producing components of HVAC equipment and other like equipment.

### SUMMARY OF THE INVENTION

Disclosed are vibration isolation systems that overcome at least one of the disadvantages of the prior art described above. Disclosed is a vibration isolation assembly for mounting a vibration source to a support structure comprising, in combination, a first support member configured to be secured to the support structure against relative movement therebetween, a second support member configured to be secured to the vibration source against relative movement therebetween, and at least three vibration isolators located between the first and second support members and secured to the first and second support members to isolate the support structure from vibration produced by the vibration source. The vibration isolators each include an elastically flexible member supported by the first and second support members and capable of bending in response to load applied to the elastically flexible member so that the elastically flexible member oscillates in response to vibration of the vibration source to at least partially isolate the vibration source from the support structure. Longitudinal axes of each of the elastically flexible members are located within a horizontal plane and the elastically flexible members are oriented so that at least one of the elastically flexible members isolates vibration of the vibration source in every horizontal lateral direction.

Also disclosed is a vibration isolation assembly for mounting a compressor having a vertical rotational axis to a bottom pan comprising, in combination, a first support member configured to be secured to the bottom pan against relative movement therebetween, a second support member configured to be secured to the compressor against relative movement therebetween, and at least three vibration isolators located between the first and second supports and secured to the first and second support members to isolate the bottom pan from the compressor. The vibration isolators each include an elastically flexible member supported by the first and second support members and capable of bending in response to load applied to the elastically flexible member so that the elastically flexible member oscillates in response to vibration of the compressor to at least partially isolate the compressor from the bottom pan. Longitudinal axes of each of the elastically flexible members are located within a horizontal plane and the elastically flexible members are oriented so that at least one of the elastically flexible members isolates vibration of the compressor in every horizontal lateral direction.

Also disclosed is an air conditioning unit comprising, in combination, a compressor having vertically extending axis of rotation, a bottom pan, and at least three vibration isolators located between the compressor and the bottom pan to isolate the compressor from the bottom pan. The vibration isolators each include an elastically flexible member supported by the first and second support members and capable of bending in response to load applied to the elastically flexible member so that the elastically flexible member oscillates in response to vibration of the compressor to at least partially isolate the compressor from the bottom pan. Longitudinal axes of each of the elastically flexible members are located within a horizontal plane and the elastically flexible members are oriented so that at least one of the elastically flexible members isolates vibration of the compressor in every horizontal lateral direction.

From the foregoing disclosure and the following more detailed description of various preferred embodiments it will be apparent to those skilled in the art that the present invention provides a significant advance in the technology and art of vibration isolation systems. Particularly significant in this regard is the potential the invention affords for a device that is relatively inexpensive and effectively isolates shock and vibration to reduce noise. Additional features and advantages of various preferred embodiments will be better understood in view of the detailed description provided below.

### BRIEF DESCRIPTION OF THE DRAWINGS

These and further features of the present invention will be apparent with reference to the following description and drawing, wherein:

FIG. 1 is a perspective view of a residential air conditioning unit, wherein a compressor is mounted to a bottom pan of a cabinet with elastomeric mounts according to prior art.

FIG. 2 is a perspective view of a residential air conditioning unit having a compressor mounted to a bottom pan with a vibration isolation assembly according to the present invention, wherein components are removed for clarity.

FIG. 3 is an enlarged perspective view of the compressor and the vibration isolation assembly of FIG. 2, wherein the bottom pan is removed for clarity.

FIG. 4 is an enlarged, fragmented view of a portion of the residential air conditioning unit of FIG. 2 at the vibration isolation system.

FIG. 5 is an enlarged perspective view of the vibration isolation assembly of FIGS. 2 to 4.

FIG. 6 is another perspective view of the vibration isolation assembly of FIG. 5.

FIG. 7 is another perspective view of the vibration isolation assembly of FIGS. 5 and 6.

FIG. 8 is an enlarged top plan view of the vibration isolation assembly of FIGS. 5 to 7.

FIG. 9 is an enlarged front elevational view of the vibration isolation assembly of FIGS. 5 to 7.

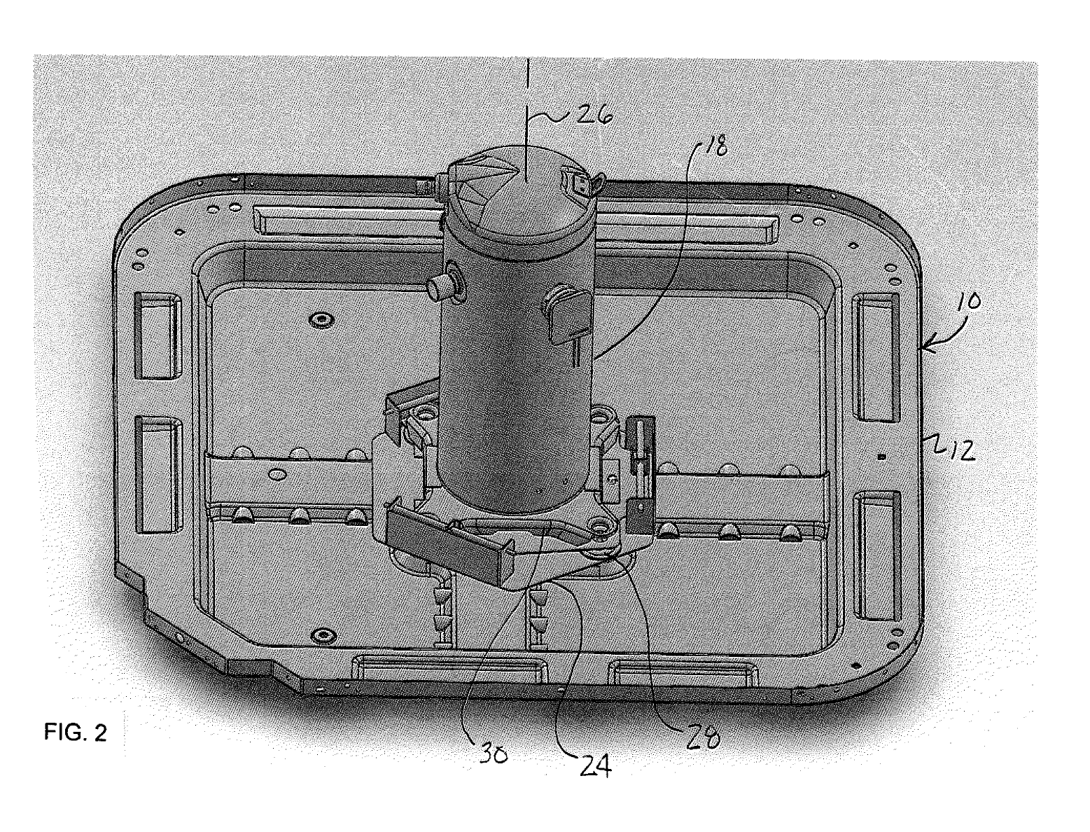

It should be understood that the appended drawings are not necessarily to scale, presenting a somewhat simplified representation of various preferred features illustrative of the basic principles of the invention. The specific design features of the vibration isolation systems as disclosed herein, including, for example, specific dimensions and shapes of the various components will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the vibration isolation systems illustrated in the drawings. In general, up or upward refers to an upward direction generally within the plane of the paper in FIG. 2 and down or downward refers to a downward direction generally within the plane of the paper in FIG. 2.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved vibration isolation systems disclosed herein. The following detailed discussion of various alternative and preferred embodiments will illustrate the general principles of the invention with regard to the specific application of isolating a compressor from a cabinet of a residential air conditioning unit. Other embodiments suitable for other applications will be apparent to those skilled in the art given the benefit of this disclosure.

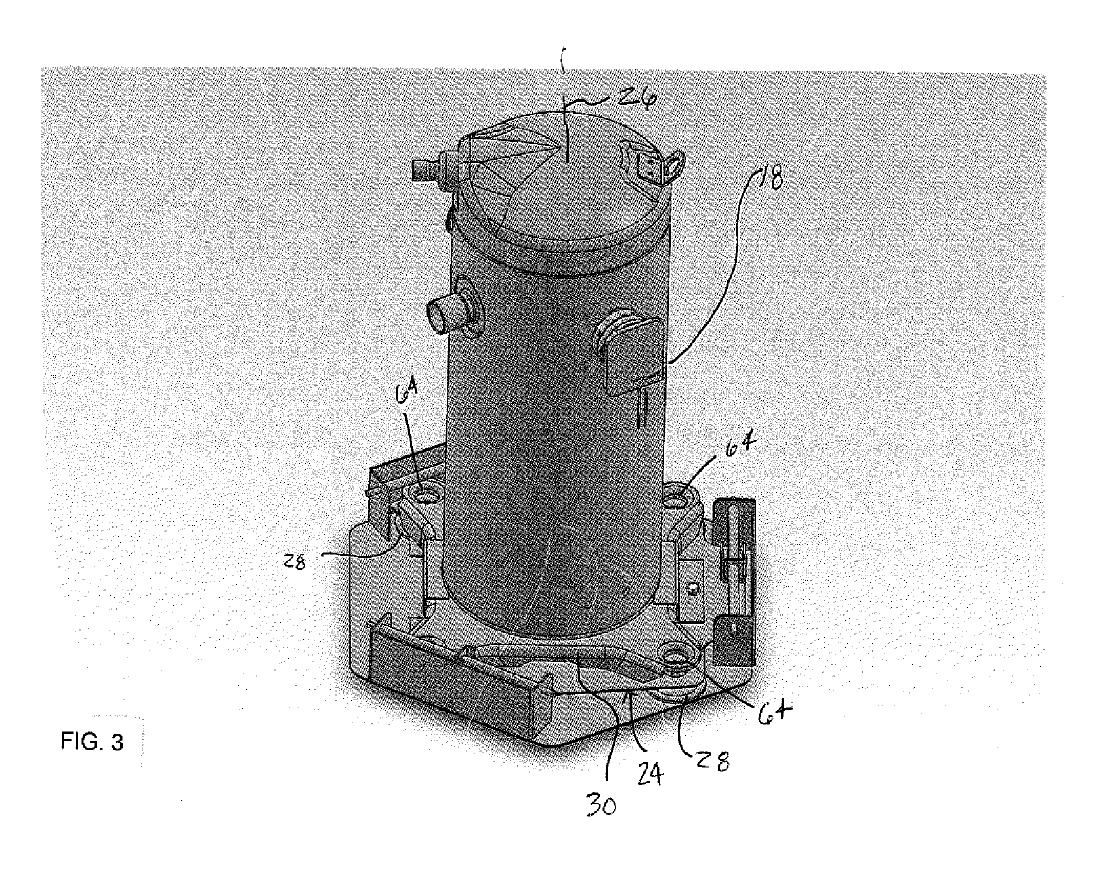

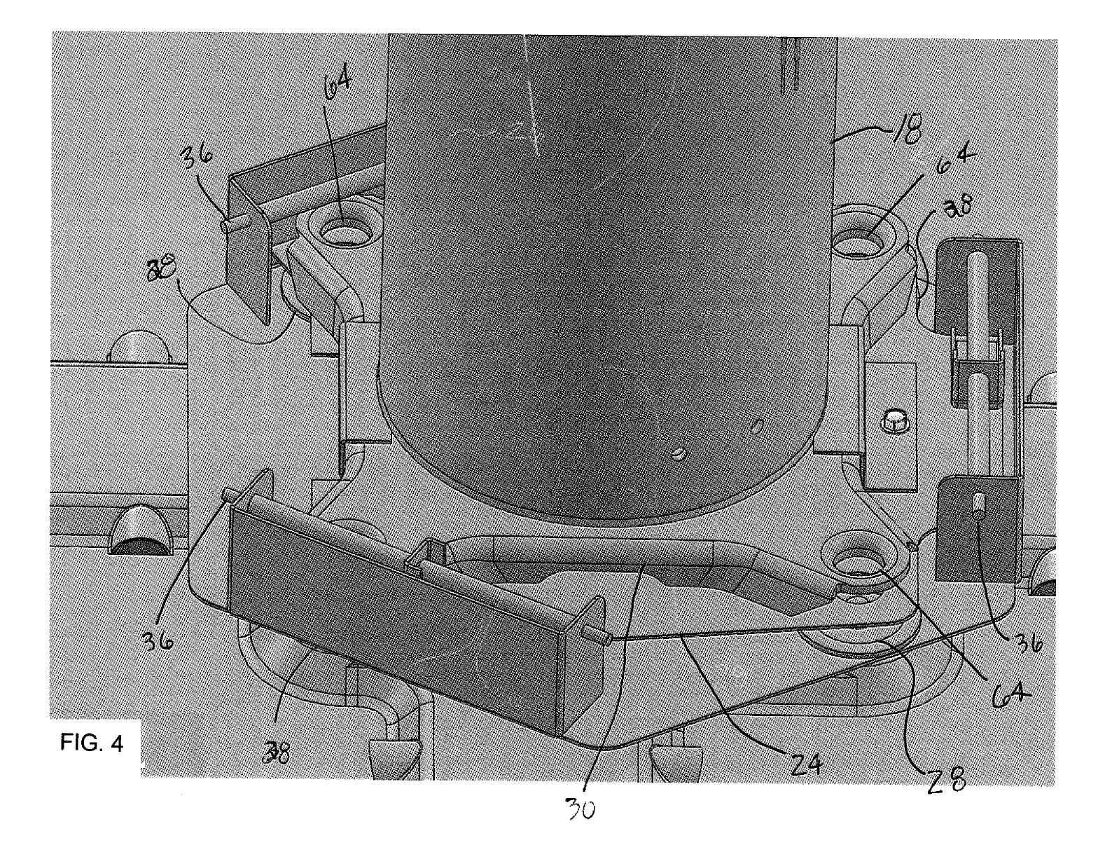

FIGS. 2 to 4 illustrate an exemplary residential air conditioning or condenser unit 10 having a vibration isolation assembly 24 according to the present invention. The illustrated air conditioning unit 10 includes a compressor 18 having vertically-extending axis of rotation, a bottom baseplate or pan 12, and the vibration isolation assembly located between the compressor 18 and the bottom pan 12 to isolate vibration of the compressor 18 from the bottom pan 12. The illustrated vibration isolation assembly 24 is secured to the top of the bottom pan 12 with four threaded fasteners but it is noted that the vibration isolation assembly 24 can alternatively be secured to the top of the bottom pan 12 with any other suitable quantity of threaded fasteners or can alternatively be secured to the top of the bottom pan 12 with any other suitable manner. The illustrated compressor 18 has a bottom plate or flange 30 that is clamped to the vibration isolation assembly 24 so that the compressor is supported by the vibration isolation assembly 24 as described in more detail hereinafter. It is noted that compressor 18 can alternatively be secured to the vibration isolation assembly 24 in any other manner.

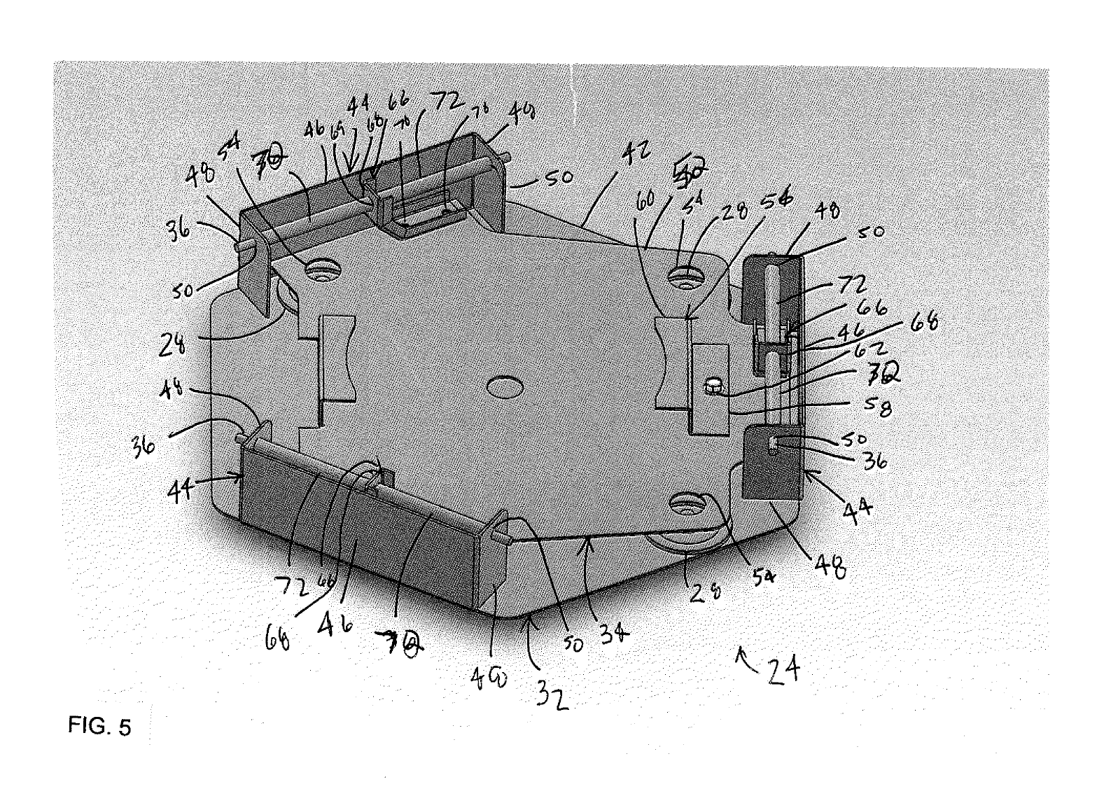

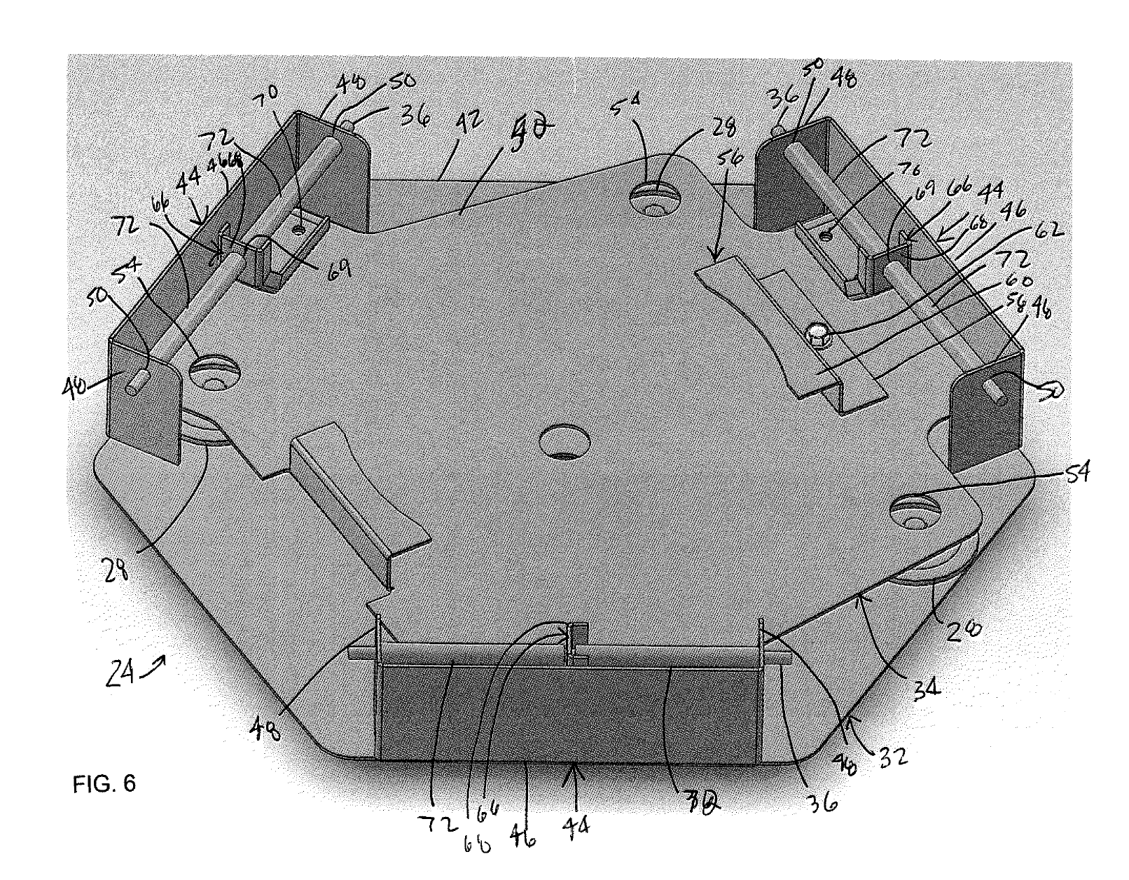

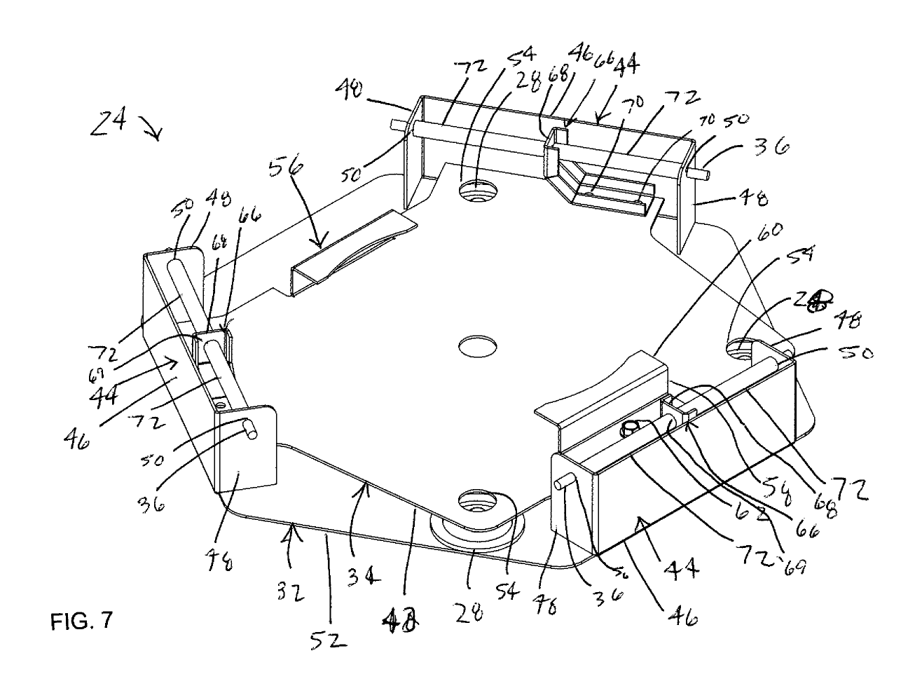

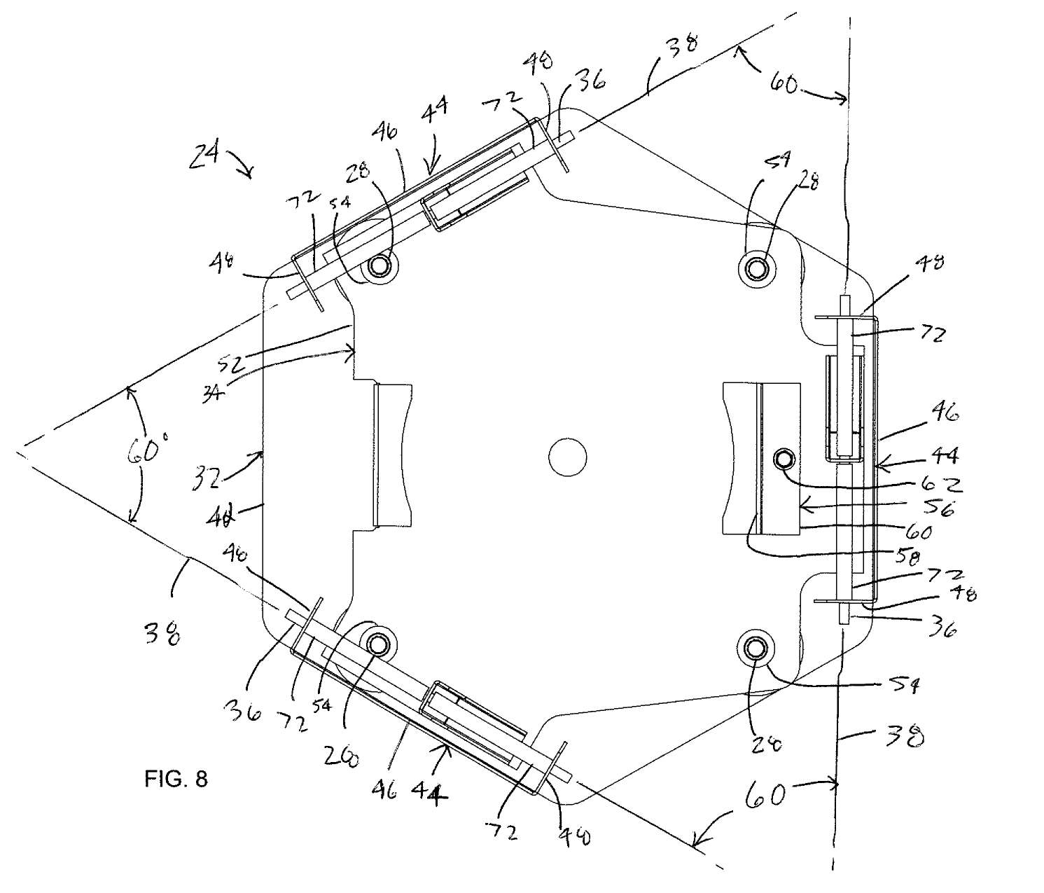

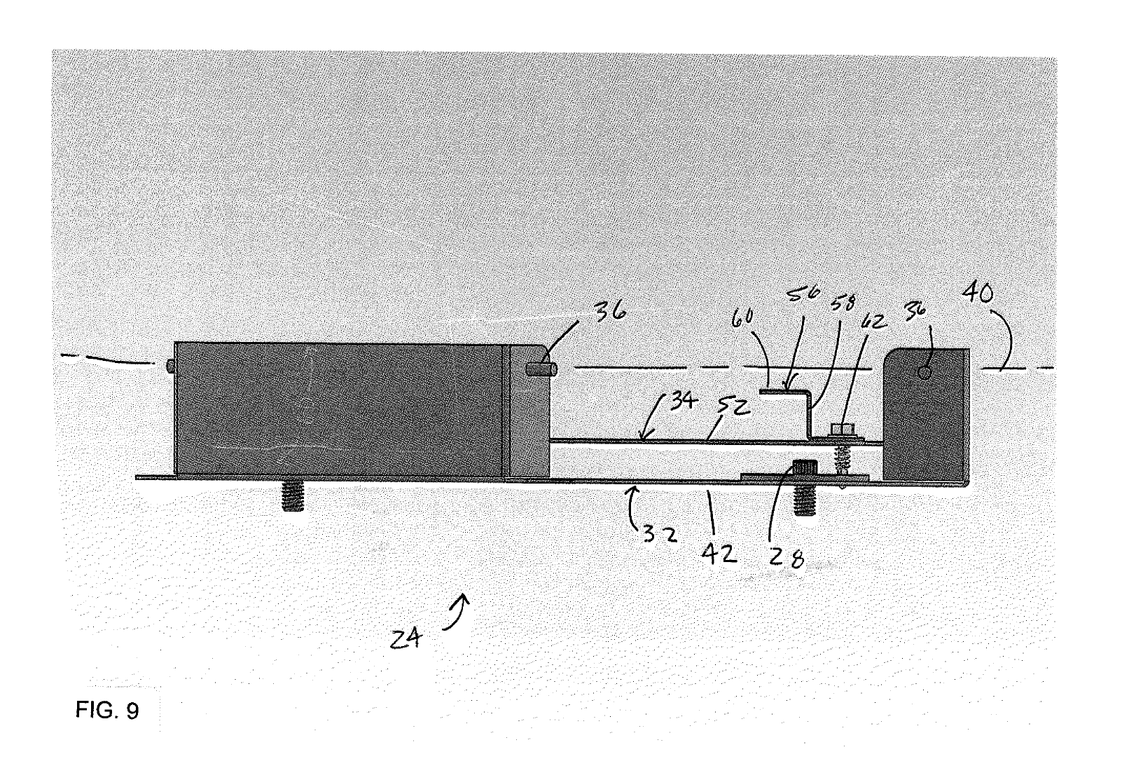

FIGS. 5 to 9 show the illustrated vibration isolation assembly 24 for mounting the compressor 18 or other vibration source to the bottom pan 12 or other support structure according to the present invention. The illustrated vibration isolation assembly 24 includes a first or bottom support member 32 configured to be secured to the support structure 12 against relative movement therebetween, a second or top support member 34 configured to be secured to the vibration source 18 against relative movement therebetween, and at least three vibration isolators 36 located between the first and second supports 32, 34 and secured to the first and second support members 32, 34 to isolate the support structure 12 from vibration produced by the vibration source 18. The illustrated vibration isolators 36 are each in the form a straight, elongate, elastically-flexible member supported by the first and second support members 32, 34 and capable of bending in response to load applied to the elastically flexible member so that the elastically flexible member oscillates in response to vibration of the vibration source 18 to at least partially isolate the vibration source 18 from the support structure 12. Longitudinal axes 38 of the illustrated elastically flexible members 36 are located within a single horizontal plane 40 and the elastically flexible members 36 are oriented so that at least one of the elastically flexible members 36 isolate vibration in every horizontal lateral direction as described in more detail hereinbelow. That is, in every horizontal direction within the horizontal plane 40 and perpendicular to the vertically-extending axis of rotational 26 of the vibration source 18.

The illustrated first or bottom support member 32 configured to be secured to the support structure 12 against relative movement therebetween. The illustrated support structure 12 is the bottom pan 12 of the residential air conditioning unit 10 but it is noted that any other suitable support structure can alternatively be utilized. The illustrated first support member 32 has a generally planar and horizontally-extending main portion 42 having a plurality of openings for the threaded fasteners 20 that cooperate with openings in the bottom pan to rigidly secure the first support member 32 to the bottom pan 12 against relative movement therebetween. The illustrated main portion 42 has four openings in a square-shaped pattern but any other suitable quantity or configuration of opening scan be utilized. It is noted that the first or bottom support member 32 can alternatively be configured to be secured to the bottom pan 12 in any other suitable manner. The illustrated first or bottom support member 32 also has a plurality support portions 44 configured for cooperation with the vibration isolators 36 to support the vibration isolators 36. The illustrated first support member 32 has three support portions 44 for use with the three illustrated three vibration isolators 36 but any other suitable quantity can be utilized depending on the number of vibration isolators 36 being utilized. The illustrated support portions 44 each have a vertically-extending main wall 46 upwardly extending from an outer edge of the main portion 42 and a pair of opposed and vertically-extending bearing walls 48 upwardly extending from the main portion 42 and inwardly extending from ends of the main wall 46. The illustrated bearing walls 48 are provided with coaxial openings 50 for supporting end portions of the vibration isolators 36 as described in more detail hereinafter. The illustrated support portions 44 are configured along the outer periphery of the main portion 42 to position the vibration isolators 36 about the vibration source 18 in a triangular configuration within the horizontal plane 40 as described in more detail hereinafter. It is noted that the illustrated main portion 42 is integrally formed to form a one-piece component with the support portions 44 by bending sheet metal but any other suitable configuration can alternatively be utilized. It is also noted that while the illustrated first or bottom support member 32 is a discrete separate component from the bottom pan 12 and secured thereto, the first or bottom support member 32 can alternatively be integrated with the bottom pan 12 if desired.

The illustrated second or top support member 34 is configured to be secured to the vibration source 18 against relative movement therebetween. The illustrated vibration source 18 is the compressor, such as a scroll compressor, having the vertical axis of rotation 26 for internal rotating components but it is noted that any other suitable vibration source can alternatively be utilized. The illustrated second support member 34 has a generally planar and horizontally-extending main portion 52 having a plurality of access openings 54 configured to provide access to the threaded fasteners 28 securing the first support member 32 to the bottom pan 18. The illustrated main portion 52 has four access openings 54 in a square-shaped pattern to cooperate with the illustrated first support member 32 but any other suitable quantity or configuration of access openings 54 can be utilized or the access openings 54 can be eliminated if the first support member 32 is secured to the first support member 12 in a manner that does not require access through the second support member 54. The illustrated second support member 34 also has a plurality of connection portions 56 for cooperation with the compressor 18 to secure the compressor 18 thereto. The illustrated second support member 32 has two connection portions 56 for use with the compressor 18 but any other suitable quantity can alternatively be utilized. The illustrated connection portions 56 each have a vertically extending main wall 58 upwardly extending from an outer edge of the main portion 52 and a horizontally-extending upper wall 60 inwardly extending from the top of the main wall 58. The illustrated connection portions 56 are configured to clamp the bottom mounting flange or bracket 30 of the compressor 18 to secure the second support member 34 to the compressor 18. It is noted that the second support member 34 can alternatively be secured to the compressor 18 in any other suitable manner and/or the compressor 18 can have any other suitable configuration. It is noted that one of the illustrated connection portions 56 is integrally formed with the main portion 52 by bending sheet metal and the other illustrated connection portion 56 is a discrete separate component from the main portion 52 and removably secured thereto with a mechanical fastener 62 for installation and removal of the compressor 18 but any other suitable configuration can alternatively be utilized. It is also noted that the compressor 18 and/or main wall 52 should be configured so that the compressor 18 does not block the access openings 54 in the main portion 52. The illustrated mounting or bottom flange 30 of the compressor 18 has fastener openings 64 that cooperate with the access openings 54 to provide access to the threaded fasteners 28 securing the first support member 32 to the bottom pan 12.

The illustrated second support member 32 also has three support portions 66 for use with one of the three vibration isolators 36 but any other suitable quantity can be utilized depending on the number of vibration isolators 36 being utilized. The illustrated support portions 66 each have an upwardly-extending bearing wall 68 parallel and centrally located between the bearing walls 48 of the first support member 32. The illustrated bearing wall 68 is provided with an opening 69 coaxial with the openings 50 in the bearing walls 48 of the first support member 32 for supporting central portions of the vibration isolators 36 as described in more detail hereinafter. The illustrated support portions 66 are configured along the outer periphery of the main portion 52 to position the vibration isolators 36 about the vibration source 18 in a triangular configuration within the horizontal plane 40 as described in more detail hereinafter. It is noted that the illustrated main portion 52 is a discrete separate component from the support portions 66 and the illustrated support portions 66 are each fastened to the main portion 52 with a pair of mechanical fasteners 70 but any other suitable configuration can alternatively be utilized such as, for example, integrally formed as a single one-piece component. It is also noted that while the illustrated second support member 34 is a discrete separate component from the compressor 18 and secured thereto, the second support member 34 can alternatively be integrated with the compressor 18 if desired.

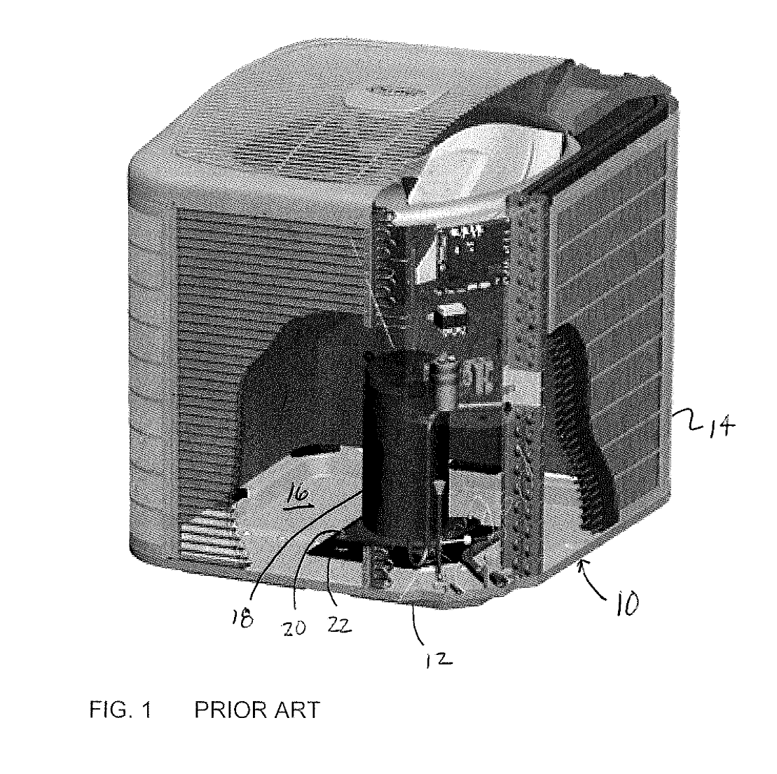

The illustrated support portions 66 upwardly extend from the main portion 52 of the second support member 34 so that the second support member 34 hangs from the central portions of elastically flexible members 36. The main portion 52 of the illustrated second support member 34 is also located above the main portion 42 of first support member 32. This configuration is useful so that the compressor 18 is positioned at substantially the same height above the bottom pan 12 as it is when the compressor 18 is supported and isolated by the prior art elastomeric mounts 22 (see FIG. 1). Thus, the illustrated vibration isolation assembly 24 is interchangeable with the elastomeric mounts 22 so that the vibration isolation assembly 24 can be used in place of the elastomeric mounts 22 with little or no alteration of other components such as, for example, connections to the compressor 18. It is noted, however, that any other suitable configuration can alternatively be utilized such as, for example, the support portions 66 can downwardly-extend from the main portion 52 of the second support member 34 so that the second support member 34 is supported above the elastically flexible members 36.

The illustrated vibration isolators 36 are located between the first and second supports 32, 34 and are secured to the first and second support members 32, 34 to isolate the support structure 12 from vibration produced by the vibration source 18. The illustrated vibration isolators 36 are each in the form of the elongate elastically-flexible members having end portions supported by the first support member 32 and a central or mid-portion supported by the second support member 34 and capable of bending in response to load applied to the central portion of the elongate elastically-flexible member so that the elongate elastically-flexible member oscillates in response to vibration of the compressor 18 to at least partially isolate the compressor 18 from the bottom pan 12. It is noted that alternatively the support members 32, 34 can be flipped or reversed if desired so that the end portions of the elongate elastically-flexible members 36 are supported by the second support member 34 and the central or mid-portion of the elongate elastically-flexible members 36 are supported by the first support member 32.

The illustrated elongate elastically-flexible members 36 are supported solely by the bearing walls 48 of the first support member 32. Each elongate elastically-flexible member 36 is capable of deflecting from an original more or less straight and horizontally-extending position to a more or less bowed position in response to changes in load in communication with the mid-portion of the elongate elastically-flexible member 36 intermediate its ends and secured to the second support member 34, with the amount of the deflection being dependent on the magnitude of the applied force within the load bearing capacity of the elongate elastically-flexible member 36. The elongate elastically-flexible member 36 is also capable of returning to its original position when the original force acting on the elastic elastically-flexible member 36 is restored. See U.S. Pat. Nos. 6,220,563, 6,595,483, and 7,086,509, the disclosures of which are expressly incorporated herein in their entireties by reference, for examples of possible variations of the vibration isolators 36.

The elastic elastically-flexible members 36 may comprise any suitable material which allows them to elastically deflect in response to changes in the applied load and return essentially to their original position when the original load is restored. The material of the elongate elastically-flexible members 36 can be any suitable metal, plastic, elastomer, composite materials, or the like. The elongate elastically-flexible members 36 should be selected to have a static deflection appropriate for the anticipated load, with greater static deflection being required to isolate lower frequency vibrations. The illustrated elongate elastically-flexible members 36 are unitary rods of solid round cross-section but any other suitable shape and/or configuration can be utilized, including but not limited to, hollow tubes, 1-beams, and the like. The elongate elastically-flexible members 36 can alternatively be composite members comprising a bundle of continuous elastic subunits held together by any suitable means.

The illustrated support portions 44 of the first support member 32 engage the elongate elastically-flexible members 36 at a distance spaced from longitudinal, unrestrained ends of the elongate elastically-flexible members 36. Also, the illustrated support portions 66 of the second support member 34 engage the elongate elastically-flexible members 36 at a central or mid-portion the elongate elastically-flexible members 36. Each of the support portions 44, 66 can be provided if desired with a sleeve bearing or the like that is sized and shaped to accommodate the shape and dimensions of the elongate elastically-flexible members 36 to reduce friction between the support portions 44, 66 and the elongate elastically-flexible members 36. The bearings can be discrete elements attached to the support portions 44, 66 but alternatively can be formed unitary therewith to form integral one-piece components. The bearings can be, for example, ABS bushings but it is noted that it can alternatively comprise any other suitable material and/or form.

The illustrated elongate elastically-flexible members are each provided with a pair sleeves or tubes 72 thereon and between the support portion 44 of the first support members 32 and the support portion 66 of the second support member 34 with one on each side of the support portion 66 of the second support member 34 to limit axial movement of the elongate elastically-flexible members 36 relative to at least one of the first and second support members 32, 34. Configured in this manner, the ends of the sleeves or tubes 72 form abutments that limit axial movement of the elongate elastically-flexible members relative to both the first and second support members 32, 34 but still permits the elongate elastically-flexible members 36 to bend or oscillate when load is applied to the central or mid-portion of the elongate elastically-flexible members 36. The tubes 72 can be flexible tubing having an inner diameter substantially the same as the outer diameter of the elongate elastically-flexible member 36 so that the tube 72 is frictionally secured thereto against axial movement relative to the elastic elastically-flexible member 36 with a friction fit. Secured in this manner, the flexible tubing becomes relatively stiff in the axial direction to maintain the desired position of the elongate elastically-flexible member 36 relative to the first and second support members 34 without negatively impacting the vibration isolating performance of the elongate elastically-flexible member 36. Another potential benefit of the sleeves or tubes 72 is that when there is still some ‘give’ or elastic relative movement in the axial direction, that slight movement, may serve to dampen the startup torque of the compressor 18. The tubes 72 can comprise vinyl or the like. It is noted that any other suitable means for maintaining the position of the elongate elastically-flexible members 36 can alternatively be utilized such as, for example, shaft collars on the elongate elastically-flexible members, a combination of shaft collars and one or more of the tubes 72, and the like.

The illustrated vibration isolation assembly 24 includes only three of the vibration isolators 36 wherein the elongate elastically-flexible members 36 are oriented in a triangular shape with the longitudinal axis 38 of each of the elongate elastically-flexible members 36 forming an angle of 60 degrees with the longitudinal axis 38 of each of the adjacent elongate elastically-flexible members 36. Thus the illustrated elongate elastically-flexible members 36 for an equilateral triangle but it is noted that any other suitable type of triangle can alternatively be utilized. It is noted, however, that any other suitable quantity or configuration of the elongate elastically-flexible members 36 can alternatively be utilized. The illustrated elongate elastically-flexible members 36 are also configured to generally surround or encircle the compressor 18. The illustrated longitudinal axes 38 of the illustrated elongate elastically-flexible members 36 are located within the horizontal plane 40 and the elongate elastically-flexible members are each oriented in different direction within the horizontal plane 40. Therefore, at least one of the illustrated elongate elastically-flexible members 36 isolates vibration in each horizontal lateral direction within the horizontal plane 40. That is, there is not a horizontal lateral direction in which all of the elongate elastically-flexible members 36 axially extend so in each and every horizontal lateral direction, at least one of the elongate elastically-flexible members 36 will be effective to at least partially isolate a load while using only three elongate elastically-flexible members 36. The illustrated elongate elastically-flexible members 36 are also configured to generally surround or encircle the compressor 18 within the horizontal plane 40. That is, the elongate elastically-flexible members 36 are configured to extend about the compressor 18.

Any of the features or attributes of the above the above described embodiments and variations can be used in combination with any of the other features and attributes of the above described embodiments and variations as desired.

From the foregoing disclosure it will be apparent that the illustrated vibration isolation assemblies 24 according to the present invention provide improved means for isolating vibration and can be interchangeable with the prior art elastomeric mounts 22 so that the vibration isolation assembly 24 can be used in place of the elastomeric mounts 22 with little to no alteration of other components such as, for example, connections to the compressor 18. It should also be apparent that the vibration isolation assemblies 24 according to the present invention can also be more fully integrated into the air conditioning unit 10. For example, the first support member 32 can be formed as a unitary part of the bottom pan 12 and/or the second support member 34 can be formed as a unitary part of the compressor 18.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A vibration isolation assembly for mounting a vibration source to a support structure, said vibration isolation assembly comprising, in combination:
a first support member configured to be secured to the support structure against relative movement therebetween;
a second support member configured to be secured to the vibration source against relative movement therebetween;
at least three vibration isolators located between the first and second support members and secured to the first and second support members to isolate the support structure from vibration produced by the vibration source;
wherein each of the vibration isolators includes an elastically flexible member supported by the first and second support members and capable of bending in response to load applied to the elastically flexible member so that the elastically flexible member oscillates in response to vibration of the vibration source to at least partially isolate the vibration source from the support structure; and
wherein longitudinal axes of each of the elastically flexible members are located within a horizontal plane and the elastically flexible members are oriented so that at least one of the elastically flexible members isolates vibration of the vibration source in every horizontal lateral direction.

2. The vibration isolation assembly according to claim 1, wherein there are only three of the vibration isolators.

3. The vibration isolation assembly according to claim 2, wherein the elastically flexible members are configured in a triangular shape about the vibration source.

4. The vibration isolation assembly according to claim 1, wherein the elastically flexible members are rods.

5. The vibration isolation assembly according to claim 4, wherein at least one of the rods is provided with at least one tube thereon to limit axial movement of the rod relative to at least one of the first and second support members.

6. The vibration isolation assembly according to claim 1, wherein the second support member hangs from the elastically flexible members.

7. The vibration isolation assembly according to claim 6, wherein the first support member is located below the second support member.

8. A vibration isolation assembly for mounting a compressor having a vertical rotational axis to a bottom pan, said vibration isolation assembly comprising, in combination:
a first support member configured to be secured to the bottom pan against relative movement therebetween;
a second support member configured to be secured to the compressor against relative movement therebetween;
at least three vibration isolators located between the first and second supports and secured to the first and second support members to isolate the bottom pan from the compressor;
wherein each of the vibration isolators includes an elastically flexible member supported by the first and second support members and capable of bending in response to load applied to the elastically flexible member so that the elastically flexible member oscillates in response to vibration of the compressor to at least partially isolate the compressor from the bottom pan; and
wherein longitudinal axes of each of the elastically flexible members are located within a horizontal plane and the elastically flexible members are oriented so that at least one of the elastically flexible members isolates vibration of the compressor in every horizontal lateral direction.

9. The vibration isolation assembly according to claim 8, wherein there are only three of the vibration isolators.

10. The vibration isolation assembly according to claim 9, wherein the elastically flexible members are configured in a triangular shape about the compressor.

11. The vibration isolation assembly according to claim 8, wherein the elastically flexible members are rods.

12. The vibration isolation assembly according to claim 11, wherein at least one of the rods is provided with at least one tube thereon to limit axial movement of the rod relative to at least one of the first and second support members.

13. The vibration isolation assembly according to claim 8, wherein the second support member hangs from the elastically flexible members.

14. The vibration isolation assembly according to claim 13, wherein the first support member is located below the second support member.

15. An air conditioning unit comprising, in combination:
a compressor having vertically-extending axis of rotation;
a bottom pan;
at least three vibration isolators located between the compressor and the bottom pan to isolate vibration of the compressor from the bottom pan;
wherein each of the vibration isolators includes an elastically flexible member supported by the first and second support members and capable of bending in response to load applied to the elastically flexible member so that the elastically flexible member oscillates in response to vibration of the compressor to at least partially isolate the compressor from the bottom pan; and
wherein longitudinal axes of the elastically flexible members are located within a horizontal plane and the elastically flexible members are oriented so that at least one of the elastically flexible members isolates vibration of the compressor in every horizontal lateral direction.

16. The vibration isolation assembly according to claim 15, wherein there are only three of the vibration isolators.

17. The vibration isolation assembly according to claim 16, wherein the elastically flexible members are configured in a triangular shape about the compressor.

18. The vibration isolation assembly according to claim 15, wherein the elastically flexible members are rods.

19. The vibration isolation assembly according to claim 18, wherein at least one of the rods is provided with at least one tube thereon to limit axial movement of the rod relative to at least one of the first and second support members.

20. The vibration isolation assembly according to claim 15, wherein the compressor hangs from the elastically flexible members.
